(19) United States
(12) Patent Application Publication
(10) Pub. No.: US 2024/0210966 A1
(43) Pub. Date: Jun. 27, 2024

(54) PRESSURE-SENSITIVE FLOW-CONTROL VALVE

(71) Applicant: Julian BOLTE, Arnsberg (DE)

(72) Inventor: Julian BOLTE, Arnsberg (DE)

(21) Appl. No.: 18/395,904

(22) Filed: Dec. 26, 2023

(30) Foreign Application Priority Data
Dec. 27, 2022 (DE) 102022134849.0

(51) Int. Cl. G05D 7/06; F16K 37/00; F16K 1/12

(52) U.S. Cl. CPC G05D 7/0635; F16K 37/005; F16K 1/12

(57) ABSTRACT

A fluid flow-control valve has a housing having an inlet port and an outlet port and forming a flow passage extending therebetween and a valve spindle having a valve cone that fits with a valve seat formed in the flow passage for controlling flow between the inlet port and the outlet port. An elastically movable film sensor near or on the spindle has one face exposed to a static pressure of a flow of fluid in the passage and an opposite face to a total pressure of the fluid applied to the end face of the valve cone for determining a differential pressure therebetween and generating an output signal transferrable to a measured value device. Thence the signal is communicated with an evaluation device, a regulation and control device, a device for influencing the volume flow, and/or an actuating device.

### FIELD OF THE INVENTION

The present invention relates to a valve. More particularly this invention concerns a flow-control valve that is responsive to a pressure differential.

### BACKGROUND OF THE INVENTION

Such a flow-control valve for fluid media has a housing with a flow passage, an inlet port, an outlet port, and a valve spindle with a valve cone that fits a valve seat formed in the flow passage. These flow-control valves are known in particular for gaseous or liquid media in the field of supply technology in buildings. Water is usually the fluid medium.

Various fittings of a similar type are known in the prior art. For example, a fitting is known from U.S. Pat. No. 10,782,709, in which a volume-flow sensor the volume flow, referred to there as the flow section, and the device for influencing the volume flow are referred to as the valve section. The measuring technology used in this device to detect the volume flow is based on ultrasound. Although both devices are accommodated in a single-piece housing in this arrangement, the ball-valve technology on the one hand and the required measuring section length of the ultrasonic measuring on the other mean that a longer installation length of the fitting or flow controller is required. In addition, apertures must be created in the valve housing for the transmitting and receiving sensors of the ultrasonic measurement technology spaced apart in the direction of flow, in which the sensors must be positioned precisely. The arrangement of the flow section downstream of the valve section in the direction of flow is also disadvantageous because the flow turbulence generated by the valve section influences the downstream ultrasonic measurement technology and places increased demands on the measured value acquisition.

A fitting is known from EP 2 898 239 B1 in which the sensor and the device for influencing the volume flow are integrated in the valve housing. Although the sensor for volumetric flow, which also uses ultrasonic measurement technology in this case, is installed upstream of the device for influencing the volumetric flow (throttle body of the balancing valve), the required measuring section length also results in a longer installation length of the valve.

An alternative to detecting the volume flow with ultrasonic sensors is to use pressure sensors that are arranged upstream and downstream of the throttle body of a valve, for example, and measure the differential pressure across the valve.

With knowledge of the flow characteristic of the valve (volume flow as a function of the differential pressure and the valve stroke position), the volume flow for an operating point can then be determined.

In theory pressure sensors can also be used in such a way that they enable a volume-flow calculation based on Bernoulli's basic physical principle, whereby one pressure sensor records the static pressure and one pressure sensor records the total pressure and an evaluation unit calculates the dynamic pressure, also known as dynamic pressure, from the difference. With knowledge of the flow cross-section at the measuring point, the volume flow can then also be calculated (Prandtl tube).

Pressure sensors used for such tasks are very space-saving and, in particular, very flat, and are known in the state of the art as film sensors.

For example, DE 19 600 178 A1 describes a volumetric flow-measuring device that has at least one electrical film sensor for detecting, among other things, pressure fluctuations that is in the liquid flow on a sensor support and is encased in a liquid-tight envelope film.

A further example of the use of film sensors is shown in US 2011/0042774 in which the film sensor has a first support film that has at least one first conductor track. The first conductor track is preferably applied directly to the first support film as a conductive layer. Furthermore, the film sensor contains a second support film that has at least one conductor track. This second conductor track of the film sensor is preferably applied directly to the second support film. At least one electrical component is provided between the first and the second support film. The electrical component is preferably electrically contacted by the first and second conductive tracks. Flow-control valves that are used as radiator valves and have an electric actuator, as well as detection of the lift position, are known, for example, from EP 3 483 690 A1.

Flow-control valves are also known in which the flow rate is kept constant for a specified stroke position by the differential pressure across the flow-control valve acting on a membrane that acts on a further flow cross-section connected in series and formed by a control sleeve or a valve cone. As the flow rate is independent of the differential pressure, the flow rate can be taken from the valve characteristic curve for each stroke position of the flow-control valve, whereby the stroke position can be read out via the actuator. An example of this is EP 3 179 173 B1.

In earlier patent publication DE 10 2022 104 513.7, a flow measurement based on film sensor technology is described using a fitting for detecting and influencing the volume flow. This is based on pressure-sensitive film sensors that measure the static pressure and the total pressure. The flow rate can be determined by applying the Bernoulli equation and the existing flow geometry.

With the known flow-control valves with which the possibility of flow measurement exists, the sensors are installed upstream and/or downstream of the flow-control valves in or on the pipelines, so that additional installation space is required and greater installation effort is involved. The same applies to the devices for recording and evaluating measured values. Examples of this are flow-control valves with position-sensing actuators that determine the flow cross-section, and pressure sensors upstream and downstream of the flow-control valve, which calculate the flow rate using a differential pressure measurement and evaluation unit.

The use of film sensor technology for flow determination known from the earlier application enables a relatively space-saving solution that is integrated into a disk valve in particular, but due to the application of the basic equation for the one-dimensional treatment of flows according to Bernoulli, two film sensors are required that must be read out accordingly and the read-out values processed further.

### OBJECTS OF THE INVENTION

It is therefore an object of the present invention to provide an improved flow-control flow-control valve.

Another object is the provision of such an improved flow-control flow-control valve that overcomes the above-given disadvantages, in particular that can determine the volume flow by a differential pressure measurement, in particular with a sensor for detecting and influencing the volume flow and that requires very little installation space in a supply system and has a small number of parts so that it is easy to install and is only slightly susceptible to fouling.

### SUMMARY OF THE INVENTION

To attain this object, it is proposed that an apparatus for differential pressure measurement is in or near the valve cone of the valve spindle, the apparatus being designed to be acted upon by the static pressure of the flow and the total pressure that is applied to the end face of the valve cone and is designed to form the differential pressure, that the apparatus consists of at least one film sensor that is elastically movably positioned in the valve spindle or on the valve cone in order to move the film sensor elastically by the differential pressure, and in that the signal generated by the film sensor is designed to be transferred to a measured value device, the measured value device being designed in turn to communicate with at least one of the following devices:
evaluation unit,
regulation and control device,
device for influencing the volume flow, and
actuating device,
whereby the communication is wireless or wired.

The apparatus for differential pressure measurement is positioned in the area of the valve cone of the valve spindle, whereby the differential pressure is formed by the static pressure of the flow in the inlet connection of the flow-control valve and by the total pressure at the end face of the valve cone of the flow-control valve.

The apparatus for differential pressure measurement consists in particular of a film sensor that can bulge or expand due to the differential pressure, with at least one membrane carrying the film sensor.

The signal generated by the apparatus for differential pressure measurement is transmitted by the film sensor via a cable connection or, if necessary, wirelessly. The operating principle can be simplified to Bernoulli's equation, according to which the sum of geodetic pressure, dynamic pressure and static pressure along a flow tube remains constant and corresponds to the total pressure. By taking the total pressure and the static pressure, the flow velocity can be calculated using the fluid density, for example for water. Knowing the flow cross-section, the mass flow can then be calculated using the continuity equation.

According to the invention, the two pressures are not measured separately, but the differential pressure is measured directly via the film sensor that forms the apparatus for measuring the differential pressure. This directs the static pressure so that this pressure acts on the film sensor. The total pressure acts on a face of the film sensor opposite this point of action, for example via an inlet opening in the valve cone.

Preferably, the film sensor is mounted on a membrane that can bulge and/or expand due to the differential pressure.

It is also possible for the film sensor to be mounted on an elastic support.

Preferably, the film sensor can also be designed as a strain gauge.

In particular, it is also provided that the valve spindle is longitudinally displaceable in the housing.

It is particularly preferred that the valve spindle has a chamber that is closed at one end and extends from the end region facing away from the valve cone to the valve cone and, passing through the valve cone, to an outlet from the valve cone that opens into the flow passage, that the valve spindle has an opening that opens transversely out of the chamber and opens into a passage of a head piece that is inserted into a first installation socket of the housing, surrounds the valve spindle in a sealed manner over the possible travel of the valve spindle and also surrounds the opening of the passage of the head piece in a sealed manner over the length of the travel, wherein the passage of the head piece is connected via a pressure line to a second part of the housing at a location offset toward the inlet port in the direction of flow upstream of the valve seat and into which the flow passage opens, that the film sensor is inserted into the chamber near its opening into the flow passage, optionally with further parts holding it, which is designed in such a way that its first effective face of the film sensor is subjected to the total pressure and its opposite second effective face opposite the first effective face is subjected to the static pressure

This results in a very compact design so that the static pressure is conducted, for example, via a pressure line or connection to the inside of the valve spindle where this pressure acts on the film sensor. The total pressure acts on the opposite side of the film sensor and is directed to the film sensor via an opening in the valve cone. Since the valve spindle moves during use, a pressure chamber is provided in the guide area of the valve spindle in the head piece of the valve between two sealing points, which makes it possible to conduct the static pressure into the interior of the valve spindle for the entire stroke.

It is preferable that the passage is an annular passage and surrounds the valve spindle in a sealed manner.

It is also preferable for the film sensor to be connected to a device that processes the transmitted signal by a cable connection through the valve spindle.

A preferred further development is that the area of the chamber of the valve spindle, into which the film sensor is inserted, is frustoconical or funnel-shaped, specifically at its end facing the valve cone, and the valve cone is also funnel-shaped at its end facing the valve spindle in such a way that a clamping point or mounting point for the apparatus for differential pressure measurement is formed between the end edges of the funnels formed in this way, between which the outer edge of this element is fixed.

Depending on the design of the film sensor, it can be attached to a membrane so that when the membrane expands during differential pressure formation, the surface tension of the membrane is transferred to the film sensor.

However, it is also possible to allow the differential pressure to act directly on the film sensor if the sensor itself is connected to a suitable support.

Preferably to accommodate the diaphragm or the membrane directly, the valve spindle is funnel-shaped at its end facing the valve cone and the valve cone with its side facing the valve spindle is also frustoconical or funnel-shaped in such a way that a clamping point for the apparatus for measuring the differential pressure is formed between the edges of the two funnels, so that this apparatus is in a very simple and space-saving manner.

A further object of the invention is an apparatus for determining volume with differential pressure measurement, comprising a flow-control valve having the features described above by applying the Bernoulli equation with known flow geometry of the flow-control valve.

Preferably, the apparatus contains at least one of the following parts
an electronic device for recording the volume flow, and
an electronically controlled device for influencing the volume flow and is intended to use measurement signals from the sensor the volume flow for control signals for influencing the volume flow by the electronically controlled device.

It is also provided that an electrical evaluation unit is assigned to the sensor the volume flow, which directly detects the differential pressure formed from the static pressure and total pressure from a film sensor and calculates the flow velocity of the volume flow in a first calculation step using the dynamic pressure and the fluid density determined in this way and the volume flow in a second calculation step taking into account the flow cross-section and the fluid density in the flow-control valve.

It is also preferable that a controller operating with or without feedback is integrated into the electronic evaluation unit that compares the calculated volume flow with a specified set-point value and transmits an adjustment command to the device for influencing the volume flow.

It is also preferable that the electronic evaluation unit is in or on the sensor for volumetric flow or that the electronic evaluation unit is part of the apparatus for influencing the volumetric flow.

### BRIEF DESCRIPTION OF THE DRAWING

The above and other objects, features, and advantages will become more readily apparent from the following description, reference being made to the accompanying drawing in which:

FIG. 1 is a section through the inventive valve and its associated parts;

FIG. 2 is a large-scale view of a detail of FIG. 1;

FIG. 3 is a side view of a detail of the invention; and

FIG. 4 is an edge view of the detail of FIG. 3.

### SPECIFIC DESCRIPTION OF THE INVENTION

As seen in the drawing a flow-control valve for fluid media, in particular water, has a housing 1 having a part 13 forming a flow passage 2 between an inlet port 3 and an outlet port 4 and a head piece 14 in which is seated a valve spindle 5 carrying at an outer end a valve cone 6 that fits with a valve seat 7 formed in the flow passage 2.

A sensor 8 for differential pressure measurement is provided in the valve cone 6 of the valve spindle 5. It is subjected to static pressure indicated at 9 and total pressure indicated at 10 applied to the outer end face of the valve cone 6, in order to form the differential pressure. The sensor 8 consists of at least one film sensor 11 that is elastically movably positioned in a chamber 16 of the valve spindle 5 or the valve cone 6 in order to move the film sensor 11 elastically by the differential pressure. The signal generated by the film sensor 11 is designed to be transferred to a controller or evaluating device that is not shown in the drawing and that is operatively connected to different devices, for example an evaluating device a flow controller operating with or without feedback, a device for influencing the volume flow and/or an actuator for displacing the valve spindle 5. Communication with these elements can be wireless or hard wired.

As can be seen in particular in FIG. 2, the film sensor 11 is mounted on a membrane 12 that can bulge and/or stretch due to a pressure differential. In particular, of course, the film sensor 11 is mounted on an elastic support. The film sensor 11 can also be designed as a strain gauge. The valve spindle 5 is slidable in the head piece 14 carried on the part 13 so as to be longitudinally displaceable parallel to a center axis 15 of the spindle 5.

The chamber 16 extends axially along the valve spindle and is closed at a rear end thereof that extends from the head piece 14 the housing 1 on the side away from the valve cone 6, to a front end 6a on the valve cone 6 in the passage 2.

In addition, the valve spindle 5 has an hole 17 that opens transversely out of the chamber 16 and into a passage 18 of the head piece 14 that is mounted on the part 13 of the housing 1. The head piece 14 surrounds the valve spindle 5 in a sealed manner over the possible travel of the valve spindle 5. Seals 19 are provided for this purpose. The end of the passage 18 of the head piece 14 also surrounds the spindle in a sealed manner.

The passage 18 of the head piece 14 is connected via a pressure line 20 to a sensor nozzle 21 of the housing 1 that is spaced from the inlet port 3 in the direction of flow upstream of the valve seat 7 and into which the flow passage 2 opens and that forms a sensor port 22.

The film sensor 11 is positioned in the chamber 16 near its opening into the flow passage 2, together with the other parts holding it if necessary. It is designed and in such a way that one of its faces is subjected to the total pressure shown at 10 and its opposite face is subjected to the static pressure shown at 9.

In addition, the end of the passage 18 in the head piece 14 is formed as an annular compartment 23 that surrounds the valve spindle 5 and that is also sealed by axially flanking seals 19.

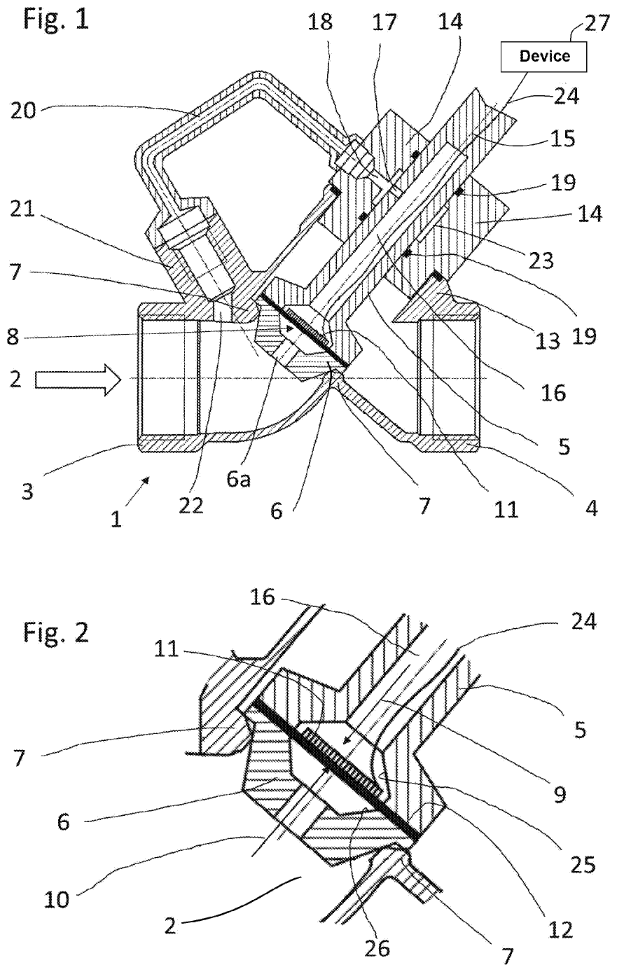

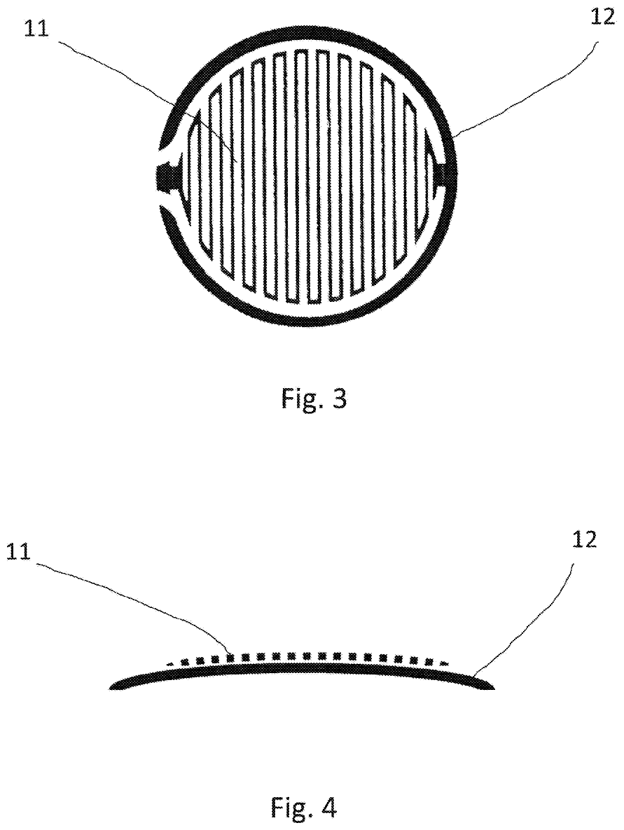

The film sensor 11 is connected to an unillustrated device that processes the transmitted signal by a cable 24 (FIG. 1) that extends back through the valve spindle 5.

The widened part of the chamber 16 of the valve spindle 5 in the valve cone 6 accommodating the film sensor 11 is formed as confronting funnels 25 and 26 in the valve cone 6. The exterior valve cone 6 is also double funnel-shaped and an outer periphery of the membrane 12 is clamped between the two funnels 25 and 26 for differential pressure measurement between the subcompartments formed by the funnels 25 and 26.

The flow-control valve shown in the drawing is functionally connected or can be connected to other parts of a device 27 for determining volumetric flow by differential pressure measurement, namely an electronic sensor the volumetric flow, an electronically controlled device for influencing the volumetric flow intended to use measurement signals from the sensor the volumetric flow for control signals for influencing the volumetric flow by the electronically controlled device.

The invention provides a flow-control valve or a corresponding device that requires very little installation space when installed in a supply system, since only a few parts are required that are easy to assemble overall and are only slightly susceptible to contamination.

The invention is not limited to the embodiment example, but is variable in many ways within the scope of the disclosure. All new individual and combination features disclosed in the description and/or drawing are considered to be essential to the invention.

I claim:

1. A fluid flow-control valve comprises:
a housing having an inlet port and an outlet port and forming a flow passage extending therebetween;
a valve spindle having a valve cone that fits with a valve seat formed in the flow passage for controlling flow between the inlet port and the outlet port;
means including an elastically movable film sensor near or on the spindle and having one face exposed to a static pressure of a flow of fluid in the passage and an opposite face to a total pressure of the fluid applied to the end face of the valve cone for determining a differential pressure therebetween and generating an output signal transferrable to a measured value device and thence communicable with at least one of the following devices:
evaluation device,
regulation and control device,
device for influencing the volume flow, and
actuating device.

2. The flow-control valve according to claim 1, wherein the film sensor is mounted on a membrane that can bulge or/and expand due to an applied differential pressure.

3. The flow-control valve according to claim 1, wherein the film sensor is mounted on elastic support.

4. The flow-control valve according to claim 1, wherein the film sensor is a strain gauge.

5. The flow-control valve according to claim 1, wherein the valve spindle is longitudinally displaceable in the housing.

6. The flow-control valve according to claim 1, wherein the valve spindle has a chamber closed at a rear end and extending from the rear end region to and through the valve cone to a front end forming an outlet that opens into the flow passage, the valve spindle has a hole that opens transversely out of the chamber and into a passage of a head piece of the housing that surrounds the valve spindle in a sealed manner over a travel of the valve spindle and also surrounds a hole of a passage of the head piece in a sealed manner over the length of the travel, the passage of the head piece being connected via a pressure line to a sensor inlet spaced upstream in a direction of flow in the passage such that the film sensor lies in the chamber near front end opening into the flow passage such that one face of the film sensor is acted upon by the total pressure and an opposite face thereof is acted upon by the static pressure.

7. The flow-control valve according to claim 6, wherein the passage is an annular passage and surrounds the valve spindle in a sealed manner.

8. The flow-control valve according to claim 7, wherein the film sensor is connected by a cable through the valve spindle to a device for processing the transmitted signal.

9. The flow-control valve according to claim 8, wherein a region of the chamber of the valve spindle in which the film sensor is positioned is funnel-shaped adjacent the valve cone, and the valve cone is also funnel-shaped at its end facing the valve spindle in such a way that a clamping point or mounting point for the film sensor is formed between outer peripheries of the funnels thus formed.

10. An apparatus for determining volumetric flow by differential pressure measurement, comprising a flow-control valve according to claim 1 by applying the Bernoulli equation with known flow geometry of the flow-control valve.

11. The apparatus according to claim 10, wherein the apparatus further comprises at least one of the following parts
an electronic device for recording volume flow,
an electronically controlled device for influencing the volume flow and using measurement signals from the sensor to determine the volume flow for control signals for influencing the volume flow by the electronically controlled device.

12. The apparatus according to claim 10, wherein the sensor of volume flow has an electrical evaluation unit that directly detects the differential pressure formed from the static pressure and total pressure by the film sensor and calculates a flow rate of the volume flow in a first calculation step using this dynamic pressure and fluid density, and calculates the volume flow in a second calculation step with knowledge of the flow cross-section and the fluid density in the flow-control valve.

13. The apparatus according to claim 10, further comprising:
a controller operating with or without feedback and integrated into the electronic evaluation unit for comparing the a volume flow with a predetermined set-point value and transmitting an actuating command to the apparatus for influencing volume flow.

14. The apparatus according to claim 11, wherein the electronic evaluation unit is in or on the sensor of volumetric flow or in the electronic evaluation unit is a part of the apparatus for influencing the volumetric flow.
